(19) United States
(12) Patent Application Publication
(10) Pub. No.: US 2008/0099287 A1
(43) Pub. Date: May 1, 2008

(54) Disc Brake

(76) Inventor: Lars Severinsson, Hishult (SE)

Correspondence Address: ST. ONGE STEWARD JOHNSTON & REENS, LLC, 986 BEDFORD STREET, STAMFORD, CT, 06905-5619, US

(21) Appl. No.: 11/965,370

(22) Filed: Dec. 27, 2007

Related U.S. Application Data
(63) Continuation of application No. PCT/EP2006/063478, filed on Jun. 22, 2006.

(30) Foreign Application Priority Data
Jun. 27, 2005 (SE) 0501491-5

(51) Int. Cl. F16D 55/46

(52) U.S. Cl. 188/72.2

(57) ABSTRACT

A disc brake includes a mechanism for bringing at least one brake pad into engagement with a rotating brake disc. The brake pad is movable, in relation to the disc brake itself, to a certain extent together with the brake disc. A guiding mechanism is provided for positively guiding the brake pad in the tangential or rotational direction of the brake disc.

### CROSS-REFERENCE TO RELATED APPLICATIONS

The present application is a continuation of pending International patent application PCT/EP2006/063478 filed on Jun. 22, 2006 which designates the United States and claims priority from Swedish patent application 0501491-5 filed on Jun. 27, 2005, the content of which is incorporated herein by reference.

### FIELD OF THE INVENTION

The present invention relates to a disc brake with self-servo effect, comprising
a movable ramp plate connected to a front brake pad holder with a front brake pad for engagement with the brake disc,
a ramp bridge, stationary in relation to the ramp plate,
rollers movable in ramps in surfaces facing each other of the ramp plate and the ramp bridge, and
means for applying a control force on the ramp plate substantially transverse to the brake disc,
the arrangement being such that a movement of the ramp plate in the tangential direction of the brake disc will cause it to move towards or away from the brake disc.

### BACKGROUND OF THE INVENTION

In most disc brake designs the brake pad is force-transmittingly guided so as to be movable substantially only perpendicularly to the brake disc.

An example of a disc brake with a movable brake pad as set out above is a disc brake with self-servo effect. It is well known in the art that a self-servo effect for a disc brake may be obtained by applying a brake pad against the rotating brake disc, where the brake pad is tangentially movable in relation to the brake disc over inclined ramp means or the like.

The basic problem with such designs was earlier the relatively poor controllability, but actuation by electric motors controlled by modern electronics and sensors has generally solved this problem.

A disc brake with self-servo effect as defined above is disclosed in WO 03/071150 from the same applicant as in the present case.

Such a disc brake can be used for any kind of application, such as rail or road vehicles. The disc brake according to the present invention, however, is primarily intended for heavy road vehicles, such as trucks, buses and trailers, but is not limited to such use.

A brake pad, which is movable to a certain extent when applied against a rotating brake disc, will be exposed to a certain moment striving to rotate the brake pad around an axis which is parallel with the brake disc axis and normally within the friction surface of the brake pad. This may not be acceptable.

### SUMMARY OF THE INVENTION

An object with the present invention is to remove the negative effects of the moment applied to the movable brake pad. This is according to the invention attained by guiding means, separate from the rollers, for positively guiding the brake pad in the tangential or rotational direction of the brake disc, in the form of support means, which are arranged in the disc brake and support the front brake pad holder against rotating or tilting under the action of a moment from the rotating brake disc.

These guiding means, when being in the form of rolls, may be rotatably arranged in the ramp bridge for engagement—at rotation of the brake disc in a direction corresponding to movement forwards of the vehicle on which the brake disc is mounted—with the front brake pad holder at suitable locations for preventing tilting of the latter.

For movements of the vehicle in the reversing direction the arrangement may be simpler. Thus, slide supports may be arranged in the ramp bridge for engagement—at rotation of the brake disc in a direction corresponding to movements backwards of the vehicle on which the brake disc is mounted—with the front brake pad holder at suitable locations for preventing tilting of the latter.

The support rolls are preferably angularly displaced in relation to the longitudinal direction of the ramp plate with the same angle as the ramps in the ramp plate, so that the rolls roll in the movement direction of the ramp plate.

The front brake pad holder may be connected to the ramp plate with form engagement, which thus gives a fixed connection. However, under certain conditions such an arrangement may give rise to vibrations and noise.

In order to remove this problem the front brake pad holder may be connected to the ramp plate in a way allowing relative movements of the latter in other directions than the tangential direction. The front brake pad holder may here be spring biassed into engagement with portions of the ramp bridge in a rest position, when the brake is not applied.

Another way to practically achieve the purpose of the invention is that an arcuate journalling means is arranged between an arcuate ramp bridge sidewall and a radially outer edge of the ramp plate for positively guiding the latter in the rotational direction of the brake disc.

In this arrangement an arcuate journalling means may be arranged between an arcuate ramp bridge sidewall and a radially inner edge of the ramp plate.

In order to obtain a movement of the ramp plate in the rotational direction of the brake disc, the rollers are preferably arranged with their axes substantially radial in relation to the brake disc.

### BRIEF DESCRIPTION OF THE DRAWINGS

The invention will be described in further detail below under reference to the accompanying drawings, in which

FIG. 1 is a schematical top view, partly in section, of an exemplary embodiment of a disc brake, in which the invention may be embodied,

FIG. 2 shows a portion of FIG. 1 with a first arrangement according to the invention,

FIG. 3 is a side view corresponding to FIG. 2,

FIG. 4 shows a portion of FIG. 1 with a second arrangement according to the invention,

FIG. 5 is a side view corresponding to FIG. 4, and

FIG. 6 is a partly sectional side view of a fourth arrangement according to the invention.

### DETAILED DESCRIPTION OF THE INVENTION

In order to convey a proper understanding of the arrangement according to the invention, a special embodiment of a disc brake with self-servo effect will first be described in certain detail. It is to be noted, however, that the choice of this special embodiment is not meant to have any limiting effect on the scope of the invention, which is defined by the claims.

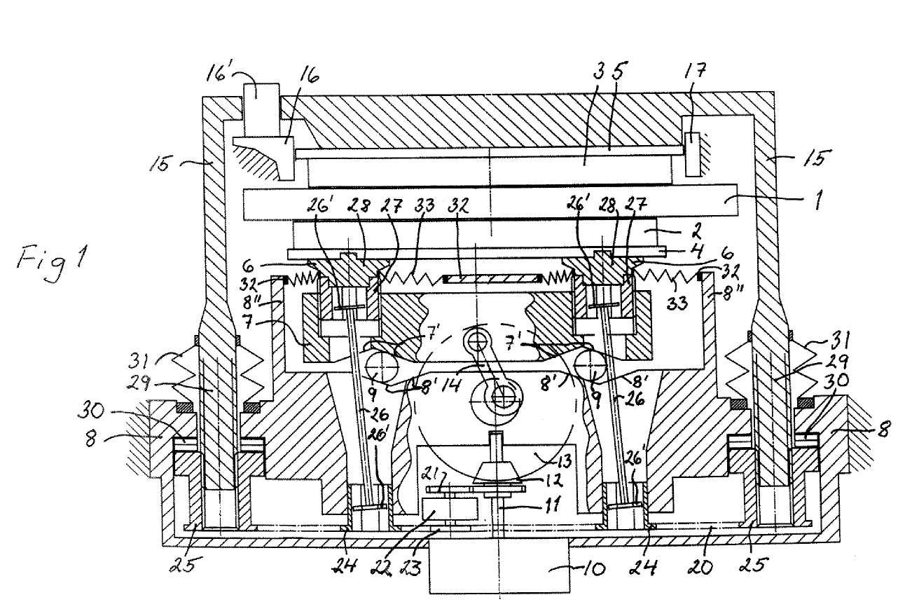

In a vehicle chassis a disc brake shown in an exemplary embodiment in FIG. 1 is placed astraddle of a rotatable brake disc 1, which is to be brakingly engaged by a front brake pad 2 and a rear brake pad 3. These brake pads 2 and 3 are attached to a front and a rear brake pad holder 4 and 5, respectively. The rear brake pad holder 5 is attached to a brake yoke 15 to be described. The brake pads may alternatively lack separate pad holders.

It will appear that in this specific embodiment the disc brake is fixedly attached in the vehicle chassis, which means that the brake disc 1 must have a certain (although limited) axial movability in relation to the disc brake, namely in the practical case in relation to its shaft. In other embodiments the disc brake may be of the so called floating type for cooperation with an axially fixed brake disc.

By adjustable distance means 6 to be described below the front brake pad holder 4 is attached to a ramp plate 7. The ramp plate 7 is in turn connected to a ramp bridge 8 by means of rollers 9 between ramps 7′ and 8′ on the ramp plate 7 and the ramp bridge 8, respectively. The rollers 9 are preferably arranged in a common roller cage (not shown) for obtaining full control and a completely synchronous movement of the rollers 9 (irrespective of their actual number). The need for a roller cage is especially relevant, if the ramps 7′ and 8′ are curved for obtaining certain brake characteristics.

The ramp bridge 8 is fixedly attached in the vehicle chassis and is provided with means for creating a control force and for maintaining a certain predetermined slack between on one hand the brake disc 1 and on the other hand the brake pads 2 and 3.

An electric motor 10 on the ramp bridge 8 can rotate a motor shaft 11 in either direction. (The unit called “electric motor” also preferably contains a gear box for reducing the rotational speed from the motor as well as a parking and safety brake arrangement.)

A bevel gear 12 arranged on the motor shaft 11 is in driving gear engagement with a bevel gear disc 13 rotationally supported by the ramp bridge 8. Eccentrically connected to the bevel gear disc 13 is a crank rod 14 pivotally connected to the ramp plate 7.

By turning the bevel gear disc 13 in either direction by means of the bevel gear 12 from the motor 10, the position of the ramp plate 7 in relation to the ramp bridge 8 can be set. When a friction engagement between on one hand the brake pad 2 (and brake pad 3, as will be described) and on the other hand the brake disc 1 has been established (over the distance means 6 between the ramp plate 7 and the brake pad holder 4), an application force amplification will be accomplished by the rollers 9 climbing their ramps 7′ and 8′ in response to a tangential movement of the ramp plate 7 caused by the friction engagement with the brake disc 1. The application force may be accurately controlled by rotating the motor 10 in either direction.

With the exception of a slack adjusting function to be described, the rear brake pad holder 5 with its rear brake pad 3 is fixedly connected to the ramp bridge 8 by means of a brake yoke 15.

Axial guiding of the brake yoke 15 and reaction force handling from the braking may either be accomplished by a first guide element 16 as shown to the left in FIG. 1 or by a second guide element 17 as shown to the right in FIG. 1, both fixed in the vehicle chassis. Both guide elements 16 and 17 have axial surfaces for handling reaction forces from the rear brake pad holder 5. The first guide element 16 has an axial guide pin 16′ cooperating with a hole in the brake yoke 15 for axial guiding of the latter, whereas the second guide element 17 guidingly cooperates with an axial surface of the brake yoke 15. Throughout this specification, the term “axial” refers to the axial direction of the brake disc 1.

The slack adjusting arrangement for the two brake pads 2 and 3 will now be described. The entire arrangement is driven by the electric motor 10 over a drive belt 20, a drive chain or the like via a gear transmission 21 from the motor shaft 11, an electromagnetic clutch 22 and a drive sprocket 23 in driving engagement with the drive belt 20. The electromagnetic clutch 22 is only engaged, when a slack adjustment is desired. The drive belt 20 may be replaced by a gear train.

The drive belt 20 drives two adjustment sleeves 24, which are rotatably arranged in the ramp bridge 8 and are intended for the slack adjustment of the front brake pad 2, and two adjustment nuts 25, which also are rotatably arranged in the ramp bridge 8 but are intended for the slack adjustment of the rear brake pad 3.

An adjustment rod 26 has end means 26′ in form engagement with one of the adjustment sleeves 24 and with one of two first adjustment screws 27, each in thread engagement with a bore in the ramp plate 7. The connection by the rod 26 means that the adjustment movement may be transmitted in spite of relative movements between the ramp plate 7 and the ramp bridge 8. The first adjustment screw 27 is rotatably connected to a socket 28 non-rotatably attached to the front brake pad holder 4 in such a way that the transmission of tangential forces is secured.

The first adjustment screw 27 and the socket 28 together form the distance means 6 with a length adjusted after the wear of the front brake pad 2.

Each end of the brake yoke 15 is formed as a second adjustment screw 29 in thread engagement with the adjustment nut 25.

The thread directions of the adjustment screws 27 and 29 are such that the distance between the two brake pad holders 4 and 5 is decreased at a rotation of the electric control motor 10 for compensating for the wear of the brake pads 2 and 3 at braking. Such a slack adjusting rotation may be separate from a rotation for controlling the application of the brake.

A force sensing means 30 of any suitable kind is arranged between the adjustment nut 25 and the ramp bridge 8 in the bottom of the bore provided therein for the nut 25. Such a force sensing means 30 can transmit signals indicative of the axial brake force; such signals can be used for feed-back at braking for controlling the electric control motor 10.

A protective bellows 31 of rubber or the like is arranged between the ramp bridge 8 and the brake yoke 15 around each second adjustment screw 29 for preventing the intrusion of moist, dirt and the like.

Further, at the side facing the front brake pad holder 4 the interior of the disc brake mechanism is protected against the intrusion of moist, dirt and the like in the following way. The ramp bridge 8 has a circumferential wall or sidewall 8″ extending towards the brake pad holder 4. In its opening, which has a considerably larger length (in the plane of the drawing) than width (transversely thereto) a lid 32 is attached. The lid 32 is provided with generally circular openings, in which outer peripheries of bellows 33 of rubber or the like are attached, whereas the inner peripheries thereof are attached to the sockets 28. These generally circular bellows will without problems allow lateral and axial movements of the first adjustment screws 27 and the sockets 28.

At the application of the brake, as controlled by the electric motor 10 via the crank rod 14, the brake pads 2 and 3 will be applied against the brake disc 1, which can be supposed to be rotating for example to the left in FIG. 1. The brake has a self-servo effect, and the brake application force will be controlled by the electric motor 10.

The rear brake pad 3 on its rear brake holder 5 in the brake yoke 15 is properly guided by the guide elements 16 or 17, whereas the design on the front side is inherently such that the ramp plate 7 with the elements connected thereto, for example the front brake pad 2, has to be movable to a certain extent in the rotation direction of the brake disc 1.

A moment is created on the brake pad 2 during braking. This moment is striving to rotate or tilt the brake pad 2 around an axis which is parallel with the brake disc axis and normally within the friction surface of the brake pad.

The main object of the invention is to take care of this moment and accomplish a guiding for the front brake pad 2 and thus for all elements connected thereto, especially the ramp plate 7, while not negatively influencing the movements required for the self-servo effect of the brake.

Reference is now made to FIGS. 2 and 3, which are rather schematical, as is also the case with FIGS. 4-6. In these figures the following elements from FIG. 1 can be seen, primarily in FIG. 2 but also where relevant in FIG. 3, which is a view perpendicular to FIG. 2: the brake disc 1, the front brake pad 2, the front brake pad holder 4, the rear brake pad 3, the rear brake pad holder 5, the ramp plate 7, the rollers 9, the crank rod 14, the two first adjustment screws 27, and the sockets 28, connected to the front brake pad holder 4.

By an arrow in full lines, the rotation direction of the brake disc 1 is in FIG. 3 indicated to be to the left (or counter-clockwise). This rotation direction is supposed to correspond to a forwards movement of the vehicle on which the brake disc is mounted. The moment applied on the brake pad 2 and thus the ramp plate 7 will strive to act by a tilting torque in the counter-clockwise direction.

In order to take care of this moment at least two support rolls 40 for the ramp plate 7 are rotatably arranged under the lower left side and over the upper right side, respectively, as viewed in FIG. 3. These support rolls 40 are preferably force-transmittingly journalled in the fixed ramp bridge 8 in a way not further described or illustrated. Other mountings may be possible. The number of support rolls 40 may be higher than two, for example four.

The support rolls 40 are preferably angularly displaced in relation to the longitudinal direction of the ramp plate 7, as most clearly appears in FIG. 2, with the same angle as the ramps 7′ of the ramp plate 7 so as to roll in the movement direction of the ramp plate.

The rolls 40 are taking up support forces on cylindrical or conical surfaces.

For rearwards movements as indicated by an arrow with broken lines in FIG. 3, when the vehicle speed is supposed to be low, it may suffice with a simpler support or guiding of the front brake pad 2 and the elements connected thereto. The clockwise moment created at brake application may in this instance be taken care of by slide supports 41, which are made of any suitable bearing material and are fixed in relation to the ramp bridge 8.

As obvious modifications support rolls 40 or the like may be used for rearwards movements and/or slide supports 41 for forwards movements.

In the arrangement shown in FIGS. 2 and 3 there is a form engagement or fixed connection between the ramp plate 7 and the front brake pad 2 via the adjustment screw sockets 28 connected to the front brake pad holder 4.

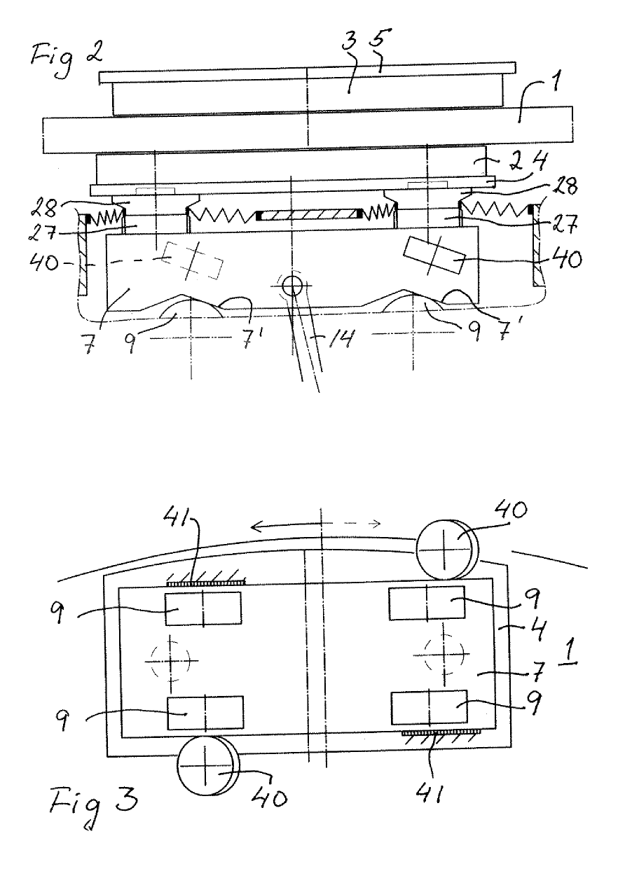

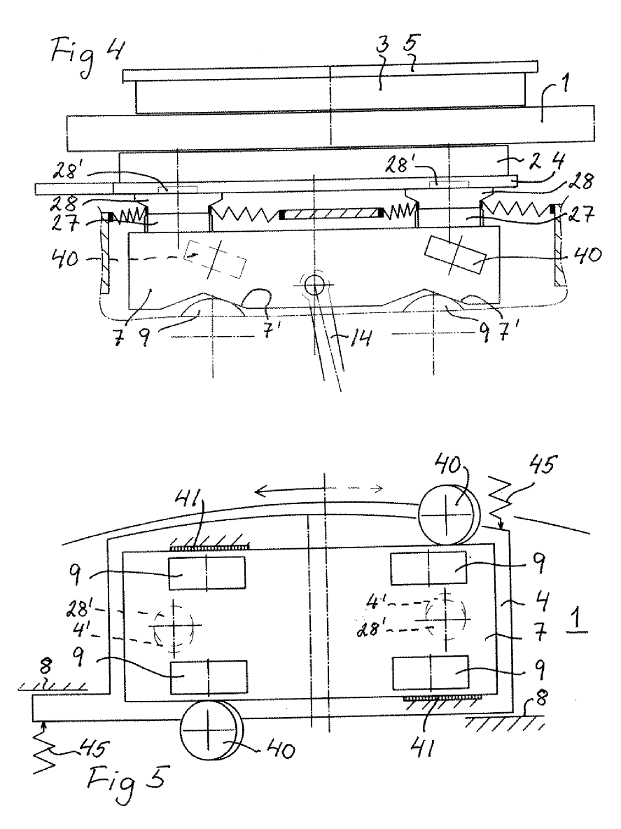

The arrangement shown in FIGS. 4 and 5 differs from the arrangement according to FIGS. 2 and 3, with which it generally corresponds, in that there is no such form engagement or fixed connection between the ramp plate 7 and the front brake pad 2. Instead, the front brake pad holder 4 is provided with oblong holes or slot-shaped holes 4′, with which end pins 28′ of the adjustment screw sockets 28 engage with a certain possibility for mutual movement in directions other than the tangential direction. This may be of importance for eliminating the transfer of vibrations from the brake pad 2 to the brake mechanism described above.

In a rest position, i e when the brake is not being applied, the front pad holder 4 may be biassed by compression springs 45 into a position guided by suitable portions of the fixed ramp bridge 8.

The guiding at braking occurs in the same manner as in the arrangement according to FIGS. 2 and 3, i e by means of support rolls 40 and slide supports 41.

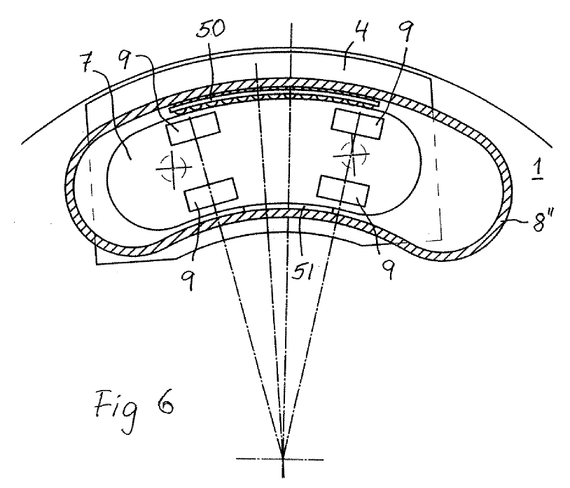

The arrangement shown in FIG. 6 differs principally from the arrangements shown in FIGS. 2-5 in that its rollers 9 are axially angularly displaced in relation to each other for accomplishing a movement for the ramp plate 7 in the rotation direction of the disc 1. Also shown in FIG. 6 are the front brake pad holder 4 and the ramp bridge sidewall 8″.

The ramp plate 7 is here guided in an arcuate path (whose center does not necessarily need to coincide with the center for the brake disc 1) by an external journalling means 50 between the ramp plate 7 and the arcuate ramp bridge sidewall 8″. This journalling means 50 may as illustrated be comprised by a number of rollers in a common roller cage. Alternatively, it may be a slide bearing or similar journalling means.

A complementary internal journalling means 51 may be arranged on the other or opposite side between the ramp plate 7 and the ramp bridge sidewall 8″. This may be a slide bearing or alternatively a bearing of the same type as the means 50.

Journalling means of the same general type as the journalling means 50 may be used in the embodiments shown in FIGS. 2-5.

Generally, it is important to note that in the shown embodiment of the disc brake, adjustable distance means 6 comprising adjustment screws 27 and sockets 28 are arranged between the front brake pad holder 4 and the ramp plate 7. However, in other, not shown embodiments the front brake pad holder may be connected directly to the ramp plate, and such embodiments are within the scope of the present invention.

Further, and even more importantly, other practical embodiments of disc brakes, where a brake pad with certain associated means is movable in relation to its brake applying mechanism, are within the scope of the present invention as defined in the appended claims.

1. A disc brake with self-servo effect, comprising
a movable ramp plate connected to a front brake pad holder with a front brake pad for engagement with the brake disc,
a ramp bridge, stationary in relation to the ramp plate,
rollers movable in ramps in surfaces facing each other of the ramp plate and the ramp bridge, and
means for applying a control force on the ramp plate substantially transverse to the brake disc,
the arrangement being such that a movement of the ramp plate in the tangential direction of the brake disc will cause it to move towards or away from the brake disc.
characterized by guiding means, separate from the rollers, for positively guiding the brake pad in the tangential or rotational direction of the brake disc in the form of support means, which are arranged in the disc brake and support the front brake pad holder against rotating or tilting under the action of a moment from the rotating brake disc.

2. A disc brake according to claim 1, wherein support rolls are rotatably arranged in the ramp bridge for engagement—at rotation of the brake disc in a direction corresponding to movement forwards of the vehicle on which the brake disc is mounted—with the front brake pad holder at suitable locations for preventing tilting of the latter.

3. A disc brake according to claim 2, wherein each support rolls are intended to take up support forces on outer cylindrical or conical surfaces.

4. A disc brake according to claim 2, wherein each support roll performs a rotational movement around a rotation axis which is fixed in relation to the ramp bridge.

5. A disc brake according to claim 2, wherein each support roll performs a rolling movement between the ramp bridge and the ramp plate without a fixed rotation axis.

6. A disc brake according to claim 2, wherein the slide supports are arranged in the ramp bridge for engagement—at rotation of the brake disc in a direction corresponding to movements backwards of the vehicle on which the brake disc is mounted—with the front brake pad holder at suitable locations for preventing tilting of the latter.

7. A disc brake according to claim 2, wherein the support rolls are angularly displaced in relation to the longitudinal direction of the ramp plate with the same angle as the ramps in the ramp plate.

8. A disc brake according to claim 2, wherein the front brake pad holder is connected to the ramp plate with form engagement.

9. A disc brake according to claim 2, wherein the front brake pad holder is connected to the ramp plate allowing relative movements of the latter in other directions than the tangential direction.

10. A disc brake according to claim 9, wherein the front brake pad holder is spring biassed into engagement with portions of the ramp bridge in a rest position, when the brake is not applied.

11. A disc brake according to claim 1, wherein an arcuate journalling means is arranged between an arcuate ramp bridge sidewall and a radially outer edge of the ramp plate for positively guiding the latter in the rotational direction of the brake disc.

12. A disc brake according to claim 11, wherein an arcuate journalling means is arranged between an arcuate ramp bridge sidewall and a radially inner edge of the ramp plate.

13. A disc brake according to claim 11, wherein the rollers are arranged with their axes substantially radial in relation to the brake disc.
